(19) United States
(12) Patent Application Publication
(10) Pub. No.: US 2023/0124613 A1
(43) Pub. Date: Apr. 20, 2023

(54) ADJUSTABLE SIDE MIRROR SYSTEM

(71) Applicant: MEKRA Lang North America, LLC., Ridgeway, SC (US)

(72) Inventors: Vijay Krishna, Columbia, SC (US); Arun Ashwathnarayan, Columbia, SC (US); Andre Magaihaes Paes, Sorocaba (BR); Tales Yasuo Kamo, Sorocaba (BR)

(73) Assignee: MEKRA Lang North America, LLC, Ridgeway, SC (US)

(21) Appl. No.: 17/965,947

(22) Filed: Oct. 14, 2022

Related U.S. Application Data
(60) Provisional application No. 63/255,561, filed on Oct. 14, 2021.

(51) Int. Cl. B60R 1/072

(52) U.S. Cl. CPC B60R 1/072

(57) ABSTRACT

An adjustable side mirror assembly for a vehicle is mountable in more than one location relative to the position of a driver of the vehicle includes an arm connectable to the vehicle at a first end and a mirror head assembly connected to a second end of the arm. The mirror head assembly includes a mirror connector configured to connect to a first mirror and a shell that envelops the mirror connector. A first mount is provided to connect the arm to the mirror head assembly in a first installation position, and a second mount is provided to connect the arm to the mirror head assembly in a second installation position.

### REFERENCE TO RELATED APPLICATIONS

This application claims priority to U.S. Provisional Application No. 63/255,561 filed on Oct. 14, 2021, the entire contents of such application is incorporated herein by reference.

### BACKGROUND

Large trucks (i.e. class 4, 5, 6, 7 and 8 trucks, tractor trailers, dump trucks, trash collection trucks, cement mixing trucks, medium duty utility trucks, etc.) that are intended for use on the highways and roadways typically include side mirrors on the left and right side of the cab of the truck. These side mirrors allow the driver to see what is beside and behind the vehicles. Different trucks have different installation requirements for the side mirrors arising from the different configurations of the trucks (i.e. trucks vary in height, some have sleeping quarters, etc.). For example, some trucks need the side mirrors mounted higher than other trucks, some trucks need the mirrors mounted farther inboard or outboard than other trucks, etc. As a result, side mirrors are usually customized to each line of trucks. What is needed is a side mirror system that allows a side mirror assembly to be installed in a variety of positions so that the same mirror assembly may be used on a variety of trucks or other vehicles.

### SUMMARY

According to one possible implementation, described herein, an adjustable side mirror assembly for a vehicle is mountable in more than one location relative to the position of a driver of the vehicle includes an arm connectable to the vehicle at a first end, a mirror head assembly connected to a second end of the arm, the mirror head assembly including a mirror connector configured to connect to a first mirror. The adjustable side mirror assembly further includes a shell that envelops the mirror connector, a first mount configured to connect the arm to the mirror head assembly in a first installation position, and a second mount configured to connect the arm to the mirror head assembly in a second installation position. The adjustable side mirror assembly may further include an adapter connected to the arm and the mirror connector, the adapter including the first mount and the second mount. The adjustable side mirror assembly may further include a third mount configured to connect the arm to the mirror head assembly in a third installation position. The adjustable side mirror assembly may further include an adapter connected to the arm and the mirror connector, the adapter including the first mount, the second mount and the third mount. The adjustable side mirror assembly may further include a first mount that corresponds to a first plurality of penetrations. The adjustable side mirror assembly may further include where the second mount corresponds to a second plurality of penetrations, the second plurality of penetrations being different from the first plurality of penetrations. The adjustable side mirror assembly may further include a second mirror connected to the mirror connector. The adjustable side mirror assembly may further include the first end of the arm having a rotatable connection to the vehicle. The adjustable side mirror assembly may further include a first mirror bracket that connects the first mirror to the mirror connector. The adjustable side mirror assembly may further include a second mirror bracket that connects the second mirror to the mirror connector. The adjustable side mirror assembly may further include where the first mirror bracket provides an adjustable connection between the first mirror and the mirror connector. The second mirror bracket may provide an adjustable connection between the second mirror and the mirror connector.

According to another possible implementation, described herein, an adapter for an adjustable side mirror assembly includes a first connection with an arm of the adjustable side mirror assembly and a second connection with a mirror head assembly of the adjustable side mirror assembly. One of the first connection or second connection includes a first mount for installing the mirror head assembly in a first position and a second mount for installing the mirror head assembly in a second position. The second connection may include the first mount and the second mount. The adapter may include a third mount for installing a mirror head in a third position. The first mount may correspond to a first plurality of apertures and the second mount may correspond to a second plurality of apertures. The third mount may correspond to a third plurality of apertures. The first position may be configured for a first automobile and the second position may be configured for a second automobile. The second connection may connect to a bracket that is configured to connect to a mirror. The first connection may connect to a pair of members of the arm.

### BRIEF DESCRIPTION OF THE DRAWINGS

FIG. 1 depicts an example environment in which the systems and methods described herein may be implemented.

FIG. 2 depicts the adjustable side mirror assembly of FIG. 1.

FIG. 3 depicts the adapter of FIG. 2.

FIG. 4 depicts the adapter and mirror connector of FIG. 2 in a first mounting position.

FIG. 5 depicts the adapter and mirror connector of FIG. 2 in a second mounting position.

FIG. 6 depicts the adapter and mirror connector of FIG. 2 in a third mounting position.

FIG. 7 depicts and exploded view of the mirror assembly of FIG. 1.

### DETAILED DESCRIPTION

The systems, methods, technologies and/or techniques (hereinafter, the “systems and methods”), described herein, may include an adjustable side mirror assembly that provides more than one installation position to locate a side mirror in more than one mounting position on a vehicle. The adjustable side mirror assembly may include an arm that is connectable to a vehicle. Generally, the arm is connected to a bracket of the vehicle. The connection may or may not be a rotatable connection. For example, and not limitation, the connection reflected in the figures below includes an arm having parallel members. In one installation of this embodiment, a vertical member is provided between the parallel members proximate the vehicle bracket, and the arm rotates around an axis defined by the vertical member. The vertical member further serves to connect the arm to the vehicle bracket. In another embodiment, one or more fasteners are located along the axis, and the arm may rotate around such fasteners. Additional functionality may be provided at the connection between the arm and the vehicle bracket, such as electric motors (i.e. to electrically rotate the side mirror), detents, etc. In other embodiments, the connection between the arm and the vehicle bracket is a fixed connection.

The arm connects to a mirror head assembly opposite the vehicle bracket. In the embodiments reflected herein, the arm connects to an adapter, which provides multiple installation positions for a mirror connector to determine the position of the mirror head assembly. In other embodiments, the adapter may have multiple installation positions for the arm and/or mirror connector, which may provide additional, or alternative, installation positions. In the embodiment reflected herein, each of the adapter’s connection positions correspond to a different connection between the adapter and a mirror connector. The connection positions permit the same mirror head assembly to be used on different vehicles. The mirror connector may further be connected to one or more mirrors (i.e. the side view mirrors), as well as a shell, which envelops the adapter, mirror connector, arm and/or portions thereof. The mirror connector may include additional components, such as mechanisms to adjust the position and/or angle of the mirror (mechanically or electronically). Because the mirror connector connects to the shell of the mirror assembly, the shell may be designed to accommodate the different installation positions, such as by having a penetration that allows the arm to be in a different position relative the shell in each connection position. The shell may include alternative components proximate the penetration to envelop the arm in each installation position.

FIG. 1 depicts an example embodiment in which the systems and methods described herein may be implemented. As shown in FIG. 1, an adjustable side mirror assembly 100 (at times, “mirror assembly 100”) may be used to locate one or more mirrors in more than one mounting position. The systems and methods may allow the adjustable side mirror assembly 100 to be assembled in different ways, each of which is configured to be used on a specific vehicle. The adjustable side mirror assembly 100 may include an arm 110 and a mirror head assembly 120. Mirror head assembly 120 may include a shell (such as shell 150), mirrors (such as mirrors 170) and/or the other components provided herein. The number and configuration of components illustrated in FIG. 1 are provided for explanatory purposes only. In practice, there may be additional components, fewer components, different components or differently arranged components than illustrated in FIG. 1. Also, in some implementations, one or more of the components of mirror assembly 100 may perform one or more functions described as being performed by another one or more of the components of mirror assembly 100. The components of mirror assembly 100 may connect in variety of ways and/or may be formed from the same piece of material.

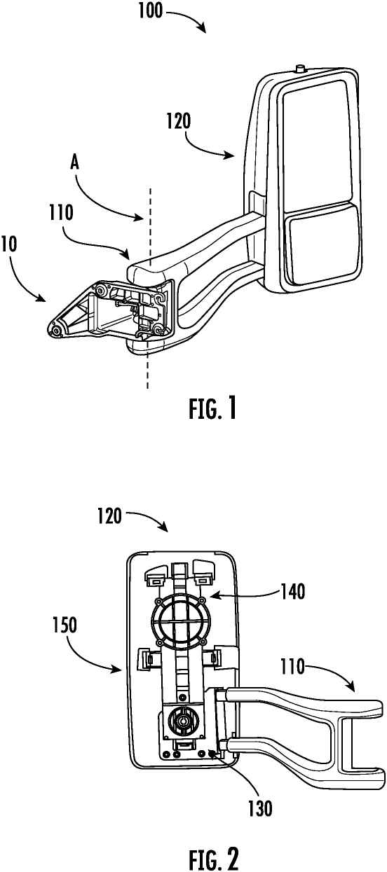

As shown in FIG. 1, the mirror assembly 100 may include an arm 110 extending from a vehicle (not shown) to connect to a mirror head assembly 120 to a vehicle. Arm 110 may connect to a bracket assembly 10 (partially shown) of the truck, such as a hinged bracket assembly that allows the adjustable side mirror assembly 100 to move from an open (or in use) position to a closed or retracted position, where the mirror head assembly 120 is rotated closer to the vehicle (for example, to protect mirror assembly 100, narrow the width of a vehicle, etc.). Arm 110 is depicted to include two generally parallel members, but, in practice, arm 110 is provided in a variety of configurations and styles. The two generally parallel members of arm 110 may be connected to vehicle bracket 10, with such connection being configured to provide an axis A. The arm 110 may rotate around axis A, and the connection (a vertical member positioned on the axis, fasteners along the axis, etc.) between the vehicle (such as via vehicle bracket 10) and arm 110 may allow mirror assembly 100 to rotate as described herein and, additionally, or alternatively, provide a variety of functionality, including electrically actuated rotation and adjustment, additional or alternative positions (open, closed, partially open, etc.) along the path of rotation set by detents, etc. Mirror head assembly 120 may include a variety of components, including one or more mirrors (such as mirrors 170, shown but not labeled in FIG. 1) in addition to, among other things, the components reflected in FIG. 2.

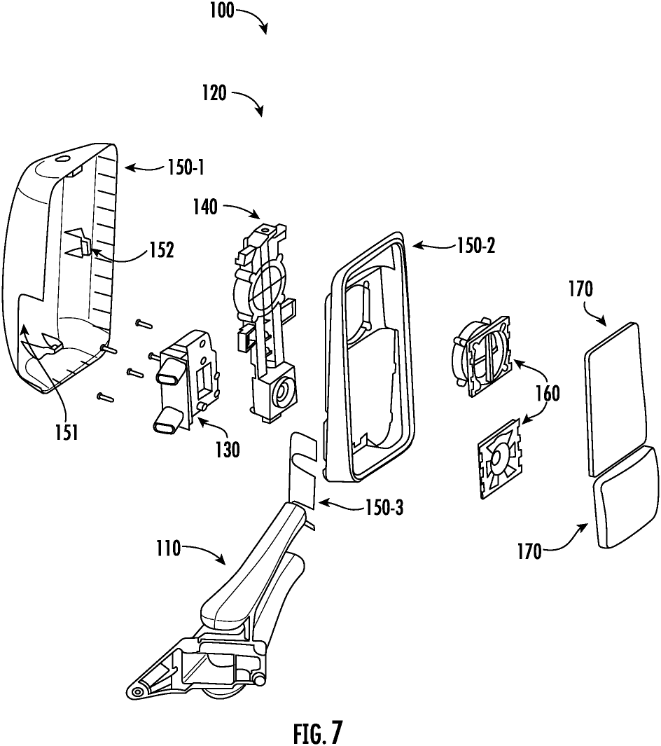

FIG. 2 depicts the mirror head assembly 120 of FIG. 1. The shell 150 has been partially removed and mirrors of mirror head assembly have been removed (mirrors) or partially removed (shell) in FIG. 2 to depict the internal components of mirror head assembly 120. As reflected in FIG. 2, mirror head assembly 120 may include an adapter 130, a mirror connector 140, a shell 150 and one or more mirrors (not shown in FIG. 2 but depicted as mirrors 170 in FIG. 7). The number and configuration of components illustrated in FIG. 2 are provided for explanatory purposes only. In practice, there may be additional components, fewer components, different components or differently arranged components than illustrated in FIG. 2. Also, in some implementations, one or more of the components of mirror head assembly 120 may perform one or more functions described as being performed by another one or more of the components of mirror head assembly 120. The components of mirror head assembly 120 may connect in variety of ways, may be formed from one or more materials, and/or may be formed from additional or alternative components.

As reflected in FIG. 2, adapter 130 may connect to arm 110 and to mirror connector 140. Mirror connector 140, as shown, connects to an upper mirror and a lower mirror proximate the two circular members of mirror connector (mirrors not shown), as well as other features of the mirror assembly (i.e. a bezel, assembly covers, etc.). Mirror connector 140 may include and/or connect to additional components configured for electrical and/or mechanical movement of the mirrors to which mirror connector 140 is connected. Shell 150 is connected to mirror connector, such as via connectors 141 (depicted in FIG. 4). Because mirror connector 140 is connected to shell 150, mirrors (not shown in FIG. 2) and to adapter 130, the position of mirror connector 140 on adapter 130 (i.e. the mounting location) may be adjusted to change the position of mirror head assembly 120, which may allow the same mirror head assembly 120 to be mounted in a variety of positions, such as by the number of different mounting locations provided by the connection between adapter 130 and mirror connector 140 or as otherwise described herein. Therefore, mirror assembly 100 may provide for an adjustable location of mirror head assembly 120 (i.e. for different vehicles, different uses, etc.) by providing a plurality of mounting positions that permit the position of one or more mirrors to be adjusted relative to the position of arm. Shell 150 may envelope the internal components of mirror head assembly 120 and may also, or alternatively, provide a bezel around one or more mirrors of mirror head assembly 120. Adapter 130 may correspond to a member that is configured to connect to arm 110 to connect mirror head assembly 120 to the vehicle. As described herein, adapter 130 may include one or more mounting positions that allow the position of mirrors to be adjusted relative the position of arm 110.

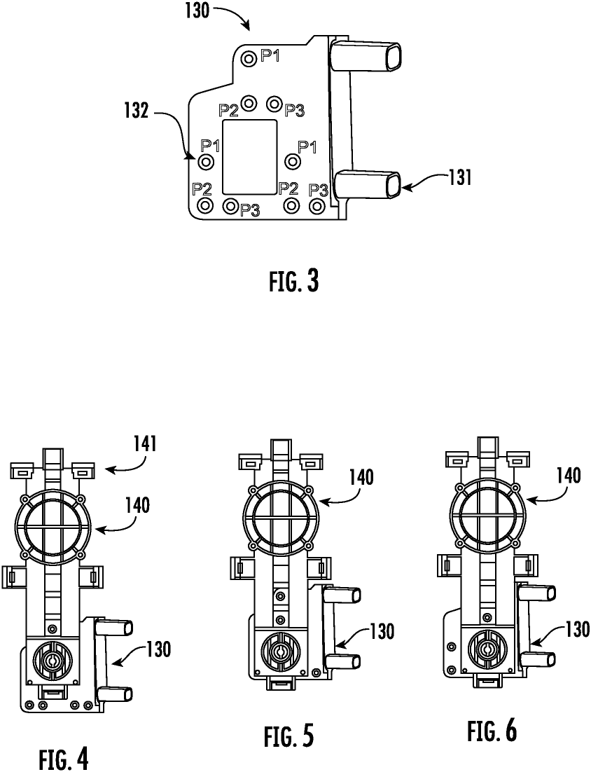

As depicted in FIG. 2, adapter 130 may be mechanically connected to arm 110, such as by having protrusions that extend into arm and are fastened in place with fasteners, adhesive, etc. FIG. 2 depicts a single mounting position for the connection between adapter 130 and arm 110 in which certain protrusions of adapter 130 may be inserted into the generally parallel members of arm 110 to connect these components. In other embodiments, adapter 130 may include additional, or alternative, mounting arrangements that provide additional, or alternative, connections between adapter 130 and arm 110, which may provide for additional or alternative mounting positions of mirror head assembly 120. As further discussed in reference to FIG. 3, adapter 130 may allow the position of mirror head assembly 120 to be adjusted by including multiple mounting positions used to connect adapter 130 to mirror connector 140.

FIG. 3 depicts the adapter 130 of FIG. 2. As shown in FIG. 3, adapter 130 may include a first connection that, in this embodiment, corresponds to arm connections 131, to connect to arm 110, and a second connection that, in this embodiment, corresponds to installation locations 132, which are configured to connect to mirror connector 140 in a plurality of positions. Adapter 130 provides a plurality of installation positions which, as further described herein, may allow mirror head 120 to be used on a plurality of vehicles. The number and configuration of the constituents if adapter 130 illustrated in FIG. 3 are provided for explanatory purposes only. In practice, there may be additional constituents, fewer constituents, different constituents or differently arranged constituents than illustrated in FIG. 3. Also, in some implementations, one or more of the constituents of adapter 130 may perform one or more functions described as being performed by another one or more of the constituents of adapter 130.

As shown in FIG. 3, arm connections 131 may be configured to connect adapter 130 to arm 110. In the embodiment shown in FIG. 3, arm connections 131 correspond to protrusions that are adapted to connect to the two generally parallel members of arm 110. In other configurations, other methods of connection may be provided. Further, adapter 130 may include additional or alternative arm connections 131 to permit more than one installation of arm 110, which may provide additional installation positions which may be used in addition to, or instead of, the alternative installation positions provided by installation locations 132.

Adapter 130 further includes installation locations 132. Installation locations 132 are reflected as penetrations (threaded, non-threaded, etc.), but installation locations 132 may correspond to any known arrangement for connecting two members (openings, mounting holes, protrusions, additional brackets, etc.). In this configuration, installation locations 132 are arranged to provide three alternative mounting positions (i.e. a first mount, a second mount and a third mount) for mirror connector 140, Position 1 or P1, Position 2 or P2, and Position 3 and P3. In other embodiments, additional (4 or more) or fewer mounting positions may be provided in other embodiments. As reflected in FIG. 3, each mounting position is provided by a set of three installation locations 132. In this configuration, three installation locations provide a mount/installation position. In other embodiments, other connection methods (i.e. other than penetrations) may be used to determine an installation location by providing the positions/mounts). Position 1 includes three installation locations 132, each identified as P1 in FIG. 3. Position 2 includes a second set of three installation locations 132, each identified as P2 in FIG. 3. Position 3 includes a third set of three installation locations 132, each identified as P3 in FIG. 3. In other embodiments, the positions may share installation locations 132 or have additional, or alternative, installation locations 132. Mirror connector 140 may connect to one of the positions (such as using three fasteners located at one of P1, P2 or P3) of adapter 130 to determine the location of mirrors relative to the arm 110 of mirror assembly 100. The different positions may be used to connect mirror head assembly 120 to a variety of vehicles.

When mirror connector 140 is connected to adapter 130 at Position 1, mirror assembly 100 may be assembled for a first vehicle. When mirror connector 140 is connected to adapter 130 at Position 2, adjustable side mirror assembly 100 may be assembled for a second vehicle. When mirror connector 140 is connected to adapter 130 at Position 3, mirror assembly 100 may be assembled for a third vehicle. Because mirror connector 140 connects to shell 150 (which surrounds the internal components of mirror head assembly 120 and provides a bezel for the mirrors), shell 150 may be configured to accommodate different positions of arm 110 relative to shell that results from the different installation positions, such as a large penetration (such as opening 151) to allow arm 110 to be located in each position and additional members for each mounting position to cover the penetration.

FIG. 4 reflects adapter 130 connected to mirror connector 140 at Position 1, FIG. 5 reflects adapter 130 connected to mirror connector 140 at Position 2 and FIG. 6 reflects adapter 130 connected to mirror connector 140 at Position 3. Because the shell 150 and mirrors (not shown in FIG. 4 but depicted as mirrors 170 in FIG. 7) are connected to mirror connector 140, the position of mirror connector 140 determines the position of mirror assembly 100 relative the driver of the vehicle. Therefore, the mounting positions, P1, P2 and P3 (and associated installation locations 132) may be selected based on the needs of a particular vehicle, allowing the same mirror assembly 100 to be used on a variety of vehicles.

FIG. 7 depicts and exploded view of the mirror assembly 100 of FIG. 1. As shown in FIG. 7, mirror assembly 100 includes a mirror head assembly 120 and an arm 110. Mirror head assembly 120 includes an adapter 130, mirror connector 140, shell 150 (depicted as a first shell 150-1, second shell 150-2 and third shell 150-3), mirror brackets 160 and mirrors 170. The number and configuration of components illustrated in FIG. 7 are provided for explanatory purposes only. In practice, there may be additional components, fewer components, different components or differently arranged components than illustrated in FIG. 7. Also, in some implementations, one or more of the components of mirror assembly 100 may perform one or more functions described as being performed by another one or more of the components of mirror assembly 100. The components of mirror assembly 100 may connect in variety of ways and/or may be formed from the same piece of material.

In the embodiment depicted in FIG. 7, the components of mirror head assembly 120 function as generally described herein. FIG. 7 depicts the different components of shell 150 as first shell 150-1, second shell 150-2 and third shell 150-3. In other embodiments, shell 150 may be constructed in other ways to suit particular applications. First shell component 150-1 is positioned opposite mirrors 170 and is connected to second shell 150-2. As depicted in FIG. 7, first shell 150-1 includes connections 152, which connect to connectors 141 of mirror connector 140 to secure mirror connectors 140 to the shell, along with the components (mirrors 170 and mirror brackets 160) connected thereto. Third shell 150-3 is disposed in an opening 151 of first shell 150-1 and connected to first shell 150-1 and/or second shell 150-2. When arm 110 connects to adapter 130, the generally parallel members of arm 110 pass through opening 151. Opening 151 is sized to permit the arm 110 to pass through first shell 150-1 when adapter 130 is connected to mirror connector 140 in any mounting position (i.e. P1, P2 or P3). Third shell 150-3 may be configured to enclose opening 151 of first shell 150-1 when arm 110 is connected to adapter 130 at a mounting position. Third shell 150-3 may be customized for one or more mounting positions so that the void of opening 151 is enclosed when mirror assembly 100 is assembled in a mounting position (P1, P)2 or P3). Because the position of the generally parallel members of arm 110 within opening 151 may vary depending on the mounting position, the design of third shell 150-3 may vary depending on the selected mounting position, but the other components of mirror assembly 100 may be the same.

Mirror brackets 160 may connect mirrors 170 to mirror connector 140. As depicted in FIG. 7, each mirror bracket 160 may connect a mirror 170 to a location on mirror connector 140. Mirror connector 140 and/or mirror brackets 160 may permit mirrors to be mechanically or electrically adjusted as described herein. In the embodiment depicted in FIG. 7, each mirror bracket 160 has an adjustable connection to mirror connector 140 such that each mirror 170 is independently adjustable.

It will be apparent that the systems and methods, as described above, may be implemented in a variety of configurations. The actual components and designs used to implement the systems and methods described herein are not limited to the configurations described above. It should be emphasized that the terms comprises and comprising, when used in this specification, are taken to specify the presence of stated features, integers, steps or components but do not preclude the presence or addition of one or more other features, integers, steps, components or groups thereof. No element, act, or instruction used in the present application should be construed as critical or essential to the implementations unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. An adjustable side mirror assembly for a vehicle, the adjustable mirror being mountable in more than one location relative to the position of a driver of the vehicle, the adjustable mirror assembly comprising:
an arm connectable to the vehicle at a first end,
a mirror head assembly connected to a second end of the arm, the mirror head assembly including
a mirror connector configured to connect to a first mirror,
a shell that envelops the mirror connector, and
a first mount configured to connect the arm to the mirror head assembly in a first installation position; and
a second mount configured to connect the arm to the mirror head assembly in a second installation position.

2. The adjustable side mirror assembly of claim 1, further comprising an adapter connected to the arm and the mirror connector, the adapter including the first mount and the second mount.

3. The adjustable side mirror assembly of claim 1 further comprising a third mount configured to connect the arm to the mirror head assembly in a third installation position.

4. The adjustable side mirror assembly of claim 3 further comprising an adapter connected to the arm and the mirror connector, the adapter including the first mount, the second mount and the third mount.

5. The adjustable side mirror assembly of claim 2 where the first mount corresponds to a first plurality of penetrations.

6. The adjustable side mirror assembly of claim 5 where the second mount corresponds to a second plurality of penetrations, the second plurality of penetrations being different from the first plurality of penetrations.

7. The adjustable side mirror assembly of claim 1 further comprising a second mirror connected to the mirror connector.

8. The adjustable side mirror assembly of claim 7 where the first end of the arm includes a rotatable connection to the vehicle.

9. The adjustable side mirror assembly of claim 1 further comprising a first mirror bracket that connects the first mirror to the mirror connector.

10. The adjustable side mirror assembly of claim 7 further comprising a second mirror bracket that connects the second mirror to the mirror connector.

11. The adjustable side mirror assembly of claim 9 where the first mirror bracket provides an adjustable connection between the first mirror and the mirror connector.

12. The adjustable side mirror assembly of claim 10 where the second mirror bracket provides an adjustable connection between the second mirror and the mirror connector.

13. An adapter for an adjustable side mirror assembly, the adapter comprising:
a first connection with an arm of the adjustable side mirror assembly,
a second connection with a mirror head assembly of the adjustable side mirror assembly,
wherein one of the first connection or second connection includes a first mount for installing the mirror head assembly in a first position and a second mount for installing the mirror head assembly in a second position.

14. The adapter of claim 13 wherein the second connection includes the first mount and the second mount.

15. The adapter of claim 13 further comprising a third mount for installing a mirror head in a third position.

16. The adapter of claim 13 wherein the first mount corresponds to a first plurality of apertures and the second mount corresponds to a second plurality of apertures.

17. The adapter of claim 15 wherein the third mount corresponds to a third plurality of apertures.

18. The adapter of claim 13 wherein the first position is configured for a first automobile and the second position is configured for a second automobile.

19. The adapter of claim 13 wherein the second connection connects to a bracket that is configured to connect to a mirror.

20. The adapter of claim 13 wherein the first connection connects to a pair of members of the arm.
